(19) United States
(12) Patent Application Publication
(10) Pub. No.: US 2022/0050623 A1
(43) Pub. Date: Feb. 17, 2022

(54) SALIENCY-BASED HIERARCHICAL SENSOR DATA STORAGE

(71) Applicant: Hewlett-Packard Development Company, L.P., Spring, TX (US)

(72) Inventors: David Murphy, Palo Alto, CA (US); Thomas da Silva Paula, Porto Alegre (BR); Carlos Eduardo Leao, Porto Alegre (BR)

(73) Assignee: Hewlett-Packard Development Company, L.P., Spring, TX (US)

(21) Appl. No.: 17/415,800

(22) PCT Filed: Mar. 21, 2019
(86) PCT No.: PCT/US2019/023303

§ 371 Date: Jun. 18, 2021

(51) Int. Cl. G06F 3/06

(52) U.S. Cl. CPC G06F 3/0655; G06F 3/0673; G06F 3/0604

(57) ABSTRACT

A hierarchical sensor data storage system includes a data storage to store processed data that includes sensor data generated by a sensor and feature vectors associated with the sensor data that are generated by a processing subsystem processing the sensor data. Another data storage may store a reduced subset of the feature vectors and associated sensor data as salient data, as determined by a saliency subsystem.

### BACKGROUND

Systems and methods for collecting and/or processing sensor data may be used to determine the state of an environment. Sensors may be placed within spaces and/or attached to systems to determine the state of the environments within and/or around them. Monitoring the state of an environment, such as a conference room, building, and/or vehicle, may be used to preserve the utility of the environment and/or protect the comfort and safety of those within it. In addition, monitoring the state of an environment surrounding a system, such as a robot and/or an autonomous vehicle, may be used to preserve the utility of such a system and/or the safety of those sharing the environment with the system.

Various types of sensors may be used that generate data or information, such as a light intensity sensor, a temperature sensor, a hygrometer, a pressure sensor, a video recording device, an audio recorder, an imaging system, and/or another sensor that generates data of measurable environmental properties.

### BRIEF DESCRIPTION OF THE DRAWINGS

The written disclosure herein describes illustrative examples that are nonlimiting and non-exhaustive. Reference is made to certain of such illustrative examples that are depicted in the figures described below.

FIG. 1A illustrates a block diagram of an example hierarchical sensor data storage system, comprising a memory to store sensor data with feature vectors and a memory to store salient data.

FIG. 1B illustrates a block diagram of an example hierarchical sensor data storage system, comprising a sensor data memory, a sensor data with feature vectors memory, and a salient data memory.

FIG. 2A illustrates an example where sensor data from a multiplicity of sensors and/or sensor types are stored in sensor data memory for a given time window.

FIG. 2B illustrates an example where sensor data from a multiplicity of sensors and/or sensor types, including an audio and video sensor, are stored in sensor data memory for a given time window.

FIG. 3 illustrates an example of video sensor data being processed by a feature vector extractor to obtain feature vectors to be associated with the video sensor data.

FIG. 4 illustrates an example sensor data with feature vector memory block for a single time window comprising temperature sensor data, audio sensor data, video sensor data, feature vectors, and/or a time window indicator.

FIG. 5A illustrates an example collection of sensor data with feature vector memory blocks for multiple time windows from time window 0 through time window N.

FIG. 5B illustrates an example collection of salient data memory blocks for multiple time windows where salient sensor data with feature vectors from FIG. 5A are retained, while other sensor data and/or feature vectors are discarded.

FIG. 6 illustrates a flow chart of an example method for implementing a hierarchical sensor data storage system.

### DETAILED DESCRIPTION

A hierarchical sensor data storage ultimately stores a reduced amount of data (e.g., a reduced amount of sensor data and/or a reduced number of feature vectors) based on saliency. For example, a system may include a data storage to store processed data (a “processed data store”) that includes (i) sensor data generated by a sensor and (ii) feature vectors associated with the sensor data. A processing subsystem may process data from a sensor to generate or extract feature vectors. The sensor data may be processed and/or stored in discrete memory blocks of uniform or varying sizes. Such discretization may be actual or conceptual in nature. In some examples, the discrete memory blocks are processed and associated with zero, one, or multiple feature vectors.

Another data storage may store salient data (a “salient data store”). A saliency subsystem may evaluate the feature vectors and/or sensor data for saliency. The saliency subsystem may identify “salient data” as a reduced subset of the feature vectors and/or a reduced subset of the associated sensor data. In some example, the hierarchical sensor data storage may further comprise a pre-processing data storage to store sensor data generated by the sensor prior to processing via the processing subsystem.

The salient data may, for example, include the feature vectors generated by the processing subsystem determined to be salient by the saliency subsystem and all the sensor data generated by the sensor. In another example, the salient data includes all the feature vectors generated by the processing subsystem and a reduced subset of the sensor data associated with the feature vectors determined to be salient by the saliency subsystem. In another example, the salient data includes the feature vectors generated by the processing subsystem determined to be salient by the saliency subsystem and the sensor data associated with the feature vectors generated by the processing subsystem determined to be salient by the saliency subsystem.

The pre-processing data storage, the first data storage, and/or the second data storage may be located in the same physical building, the same computer system, or even as partitions of the same physical storage medium. In another example, the pre-processing data storage, the first data storage, and/or the second data storage may be physically distinct data storages in close physical proximity or in remote locations relative to one another.

In some examples described herein, the pre-processing data storage is referred to as the “first data storage,” the processed data storage is referred to as the “second data storage,” and the salient data storage is referred to as the “third data storage.” In some examples, a machine-learning subsystem determines feature vectors associated with portions of sensor data from a sensor (e.g., a single sensor or multiple sensors) during a plurality of time periods. In some examples, sensor data from one or more sensors may initially be stored in one or more pre-processing data storages. A second data storage may store the sensor data and feature vectors determined by a machine-learning subsystem implementing or otherwise applying one or more of a wide variety of machine-learning models.

A saliency subsystem may evaluate at least the feature vectors. In some examples, the saliency subsystem may additionally evaluate some or all the sensor data for saliency. Saliency may be user-defined. For example, a user may define saliency to include images from a camera that include a specific object. A machine-learning model may facilitate identification of objects described in terms of one or more feature vectors. Saliency may be objectively defined. For example, salient feature vectors associated with a temperature sensor may be defined as those that indicate a rate of change in excess of a threshold rate of change. A third data storage, or salient data storage, may store a reduced set of the feature vectors and/or associated sensor data from a subset of the time periods, as determined to be salient by the saliency subsystem.

Collecting and/or processing sensor data may be used to determine the state of an environment over a period of time. Sensors may be placed within spaces and/or attached to systems to determine the state of the environments within and/or around them. Various types of sensors may be used to collect data such as light intensity, temperature, humidity, pressure, video, audio, images, and/or other measurable properties. The quantity of data collected from sensors may be large. Sensor data may be stored and/or processed. The processing of collected sensor data may be used to identify patterns of interest or other salient information. In some applications, some collected, stored, and/or processed sensor data may not be salient.

For example, a plurality of sensors and/or sensor types may be placed in an environment such as a conference room, building, and/or vehicle to measure the state of the environment over time. The data collected from the sensors, placed in this environment, may be stored in a hierarchical sensor data storage system.

A data storage, as used herein, may include any of a wide variety of computer-readable media. Examples of data storage include hard disk drives, solid state storage devices, tape drives, and the like. Data storage system may make use of processors, random access memory (RAM), read only memory (ROM), cloud-based digital storage, local digital storage, network communication, and other computing systems.

Various modules, systems, and subsystems are described herein as implementing or more functions and/or as performing one or more actions or steps. In many instances, modules, systems, and subsystems may be divided into sub-modules, subsystems, or even as sub-portions of subsystems. Modules, systems, and subsystems may be implemented in hardware, software, hardware, and/or combinations thereof.

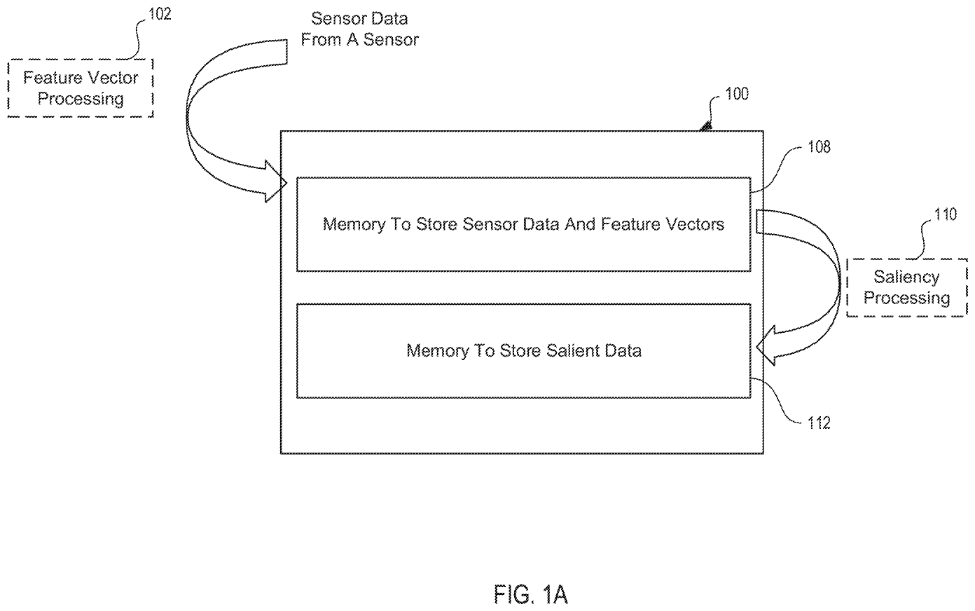

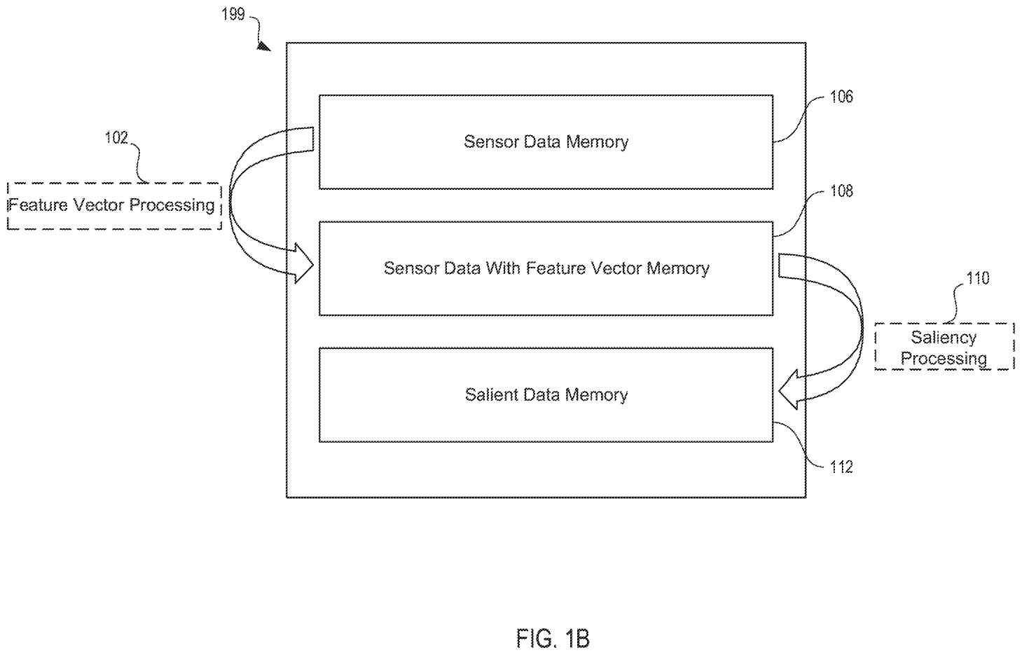

FIG. 1A illustrates an example hierarchical data storage system 100 that includes a first memory 108 to store sensor data from a sensor along with feature vectors generated by a feature vector processing subsystem 102. The hierarchical data storage system 100 may further include a second memory to store salient data 112. The salient data may comprise a subset of the feature vectors and/or a subset of the sensor data, where the saliency thereof is determined by a saliency processing subsystem 110.

FIG. 1B illustrates another example of a hierarchical data storage system 199. A sensor data memory 106 stores data from one or more sensors and, in some examples, time window indicators. For instance, sensor data collected within a particular time window may be stored in a sensor data memory block with an associated time window indicator. The length of a time window may vary by application, arbitrarily, and/or per user-specification.

Sensor data, stored in a sensor data memory, may be processed by feature vector generating processing 102. The feature vector generating processing 102 may associate feature vectors with sensor data. A second or processed memory 108 labeled as “sensor data with feature vectors memory” may store the sensor data, the associated feature vector(s), and the associated time window indicator(s). In some example, if feature vector generating processing 102 associate feature vectors with any sensor data within a sensor data memory block, then all sensor data from that sensor data memory block may be stored in a memory block of sensor data and associated feature vectors. The memory block, in some example, may further include the associated time window indicator.

Saliency processing 110 may be used to determine which memory blocks of sensor data and associated feature vectors are salient. A salient data memory 112 stores the memory blocks of sensor data and associated feature vectors. If a memory block of sensor data and associated feature vector(s) contains salient sensor data, then the contents of the memory block sensor data and associated feature vector(s) are stored in the salient data memory 112. The salient data memory 112 contains at least feature vectors determined to be salient and the associated salient sensor data. In some examples, the salient data memory 112 may also include associated feature vectors, time window indicators, and/or non-salient sensor data from one or more other sensors collected within the same time window as the sensor data associated with the salient feature vectors. Memory blocks with no salient feature vectors may be discarded or at least not stored within the salient data memory 112. The resulting salient data memory 112 can be searched, queried, and/or processed further.

The sensor data memory 106, sensor data with feature vectors memory 108, and salient data memory 112 may be implemented as independent memory subsystems in disparate remote locations (e.g., connected via networks) and/or as a single storage system. In addition, the three levels of memory hierarchy may be distributed across multiple systems. For example, the sensor data memory 106 may be implemented on various sensors and/or sensor types, while the second 108 and third 112 memories are implemented elsewhere.

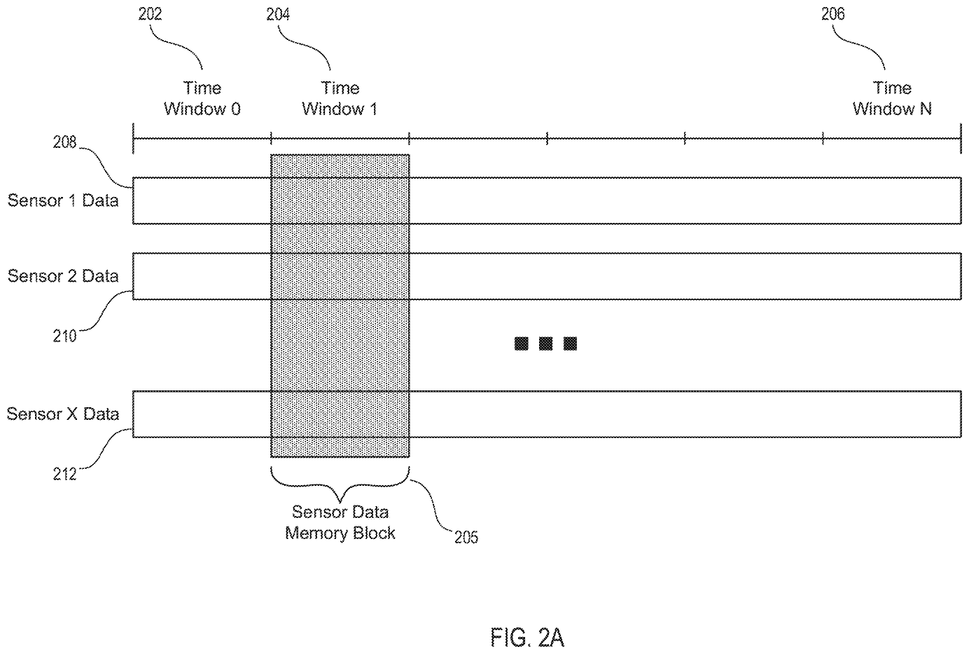

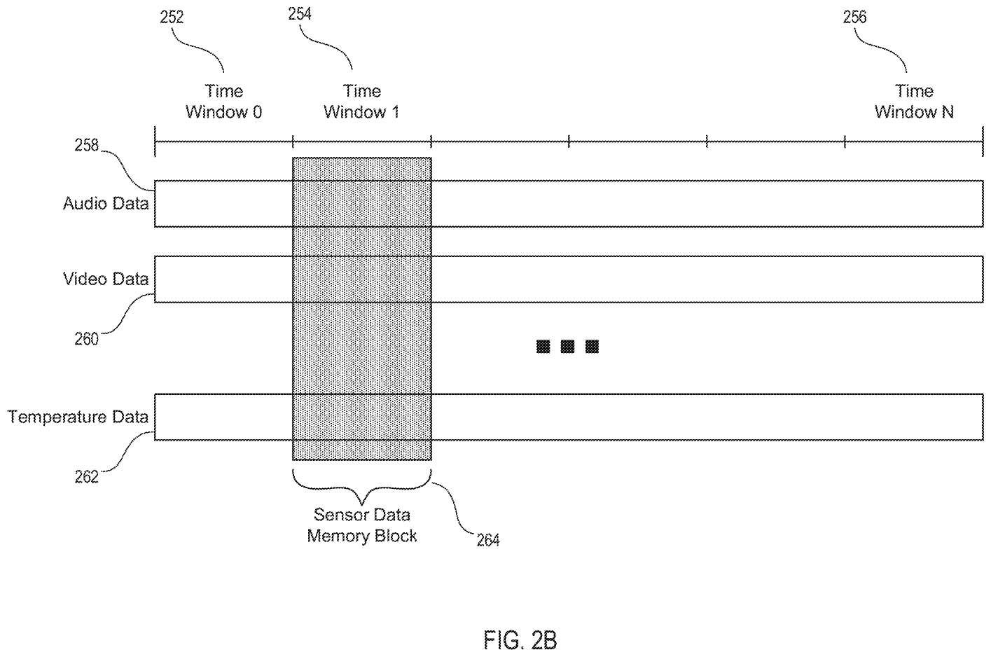

FIG. 2A illustrates a plurality of N sensors, including sensor 1 data 208, sensor 2 data 210, through sensor X data 212. Data from each sensor 208-212 is stored into a sensor data memory block 205 associated with time window 1 204. Previously collected sensor data may have been stored in an earlier sensor data memory block (not shown) associated with time window 0 202, while future collected sensor data may be stored in subsequent sensor data memory blocks (not shown) associated with time windows ranging from 2 through N 206. Further processing of the collected sensor data may proceed as described above.

In a specific example, sensors 208-212 may be part of a plurality of sensors and/or sensor types placed on a robot and/or an autonomous vehicle to measure the state of their surrounding environment over time. In another possible example, sensors 208-212 may be part of a plurality of sensors associated with a conference room or security system.

FIG. 2B illustrates such an example in which a microphone sensor collects audio data 258, the video camera collects video data 260, and the temperature sensor collects temperature data 262. The microphone sensor, the video camera, the temperature sensor, and/or other sensors of various types may be part of a robot that traverses a hallway during the day. The collected sensor data is stored in a sensor data memory block 264 with a time window indicator of 1 254. Previously collected audio, video, and temperature data may have been stored in a sensor data memory block associated with time window 0 252, while future audio, video, and temperature data may be stored in sensor data memory blocks associated with time windows ranging from 2 through N 256.

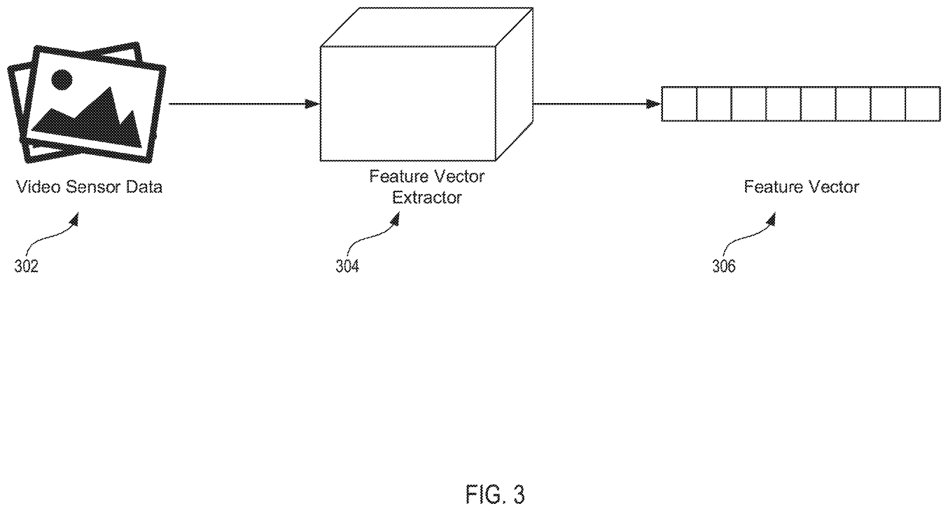

FIG. 3 illustrates video sensor data 302, which may be received directly from the sensor or stored in pre-processed sensor data memory. A machine-learning feature vector extractor 304 processes the video sensor data 302. The machine-learning feature vector extractor 304 may, for example, implement an object detection model, person detection model, and/or semantic segmentation model. In some embodiments, multiple models may be utilized . The feature vector may include the output of the multiple models, or multiple feature vectors may be associated with one set of data. A machine learning model may be an encoder from an autoencoder.

If the feature vector extractor 304 finds video sensor data containing identifiable features, the features may be identified with feature vectors 306 and associated with the video sensor data 302. The video sensor data 302, associated feature vectors 306, and an associated time window indicator are then stored as a memory block of sensor data and associated feature vector(s).

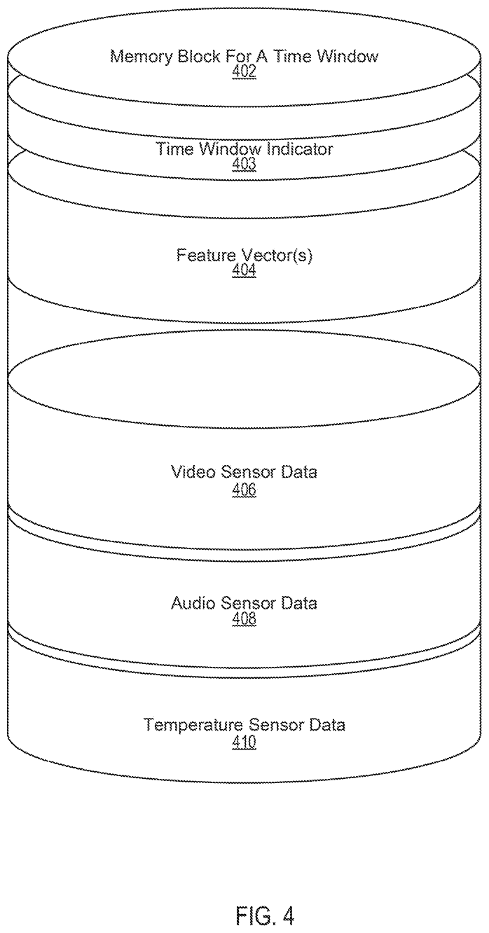

FIG. 4 illustrates a block diagram of an example memory block 402 of sensor data and associated feature vectors for a given time window. The example memory block 402 comprises a time window indicator 403, feature vector(s) 404, video sensor data 406, audio sensor data 408, and temperature sensor data 410. The feature vectors 404 may describe features of interest in the video, audio, and/or temperature sensor data 406-410. The time window indicator 403 designates a period of time in which the sensor data 406-410 within the memory block 402 was collected.

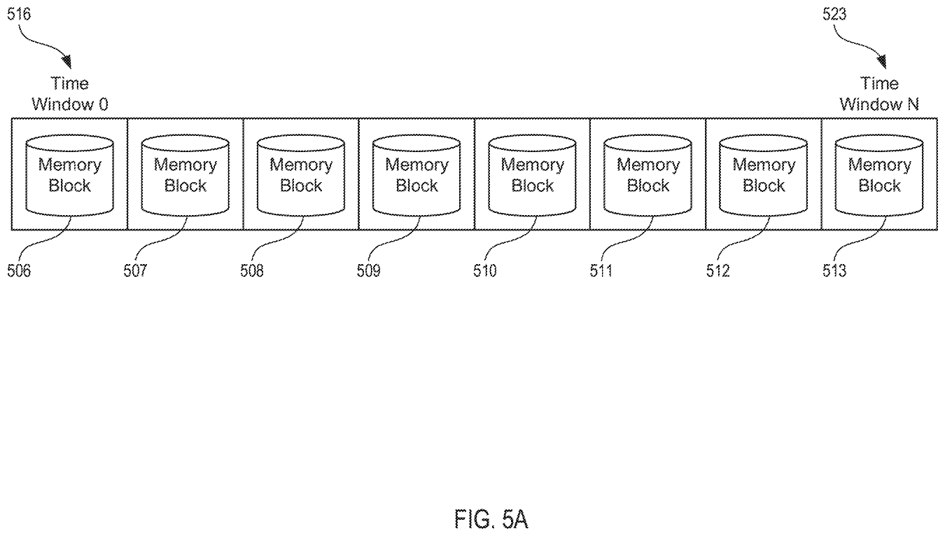

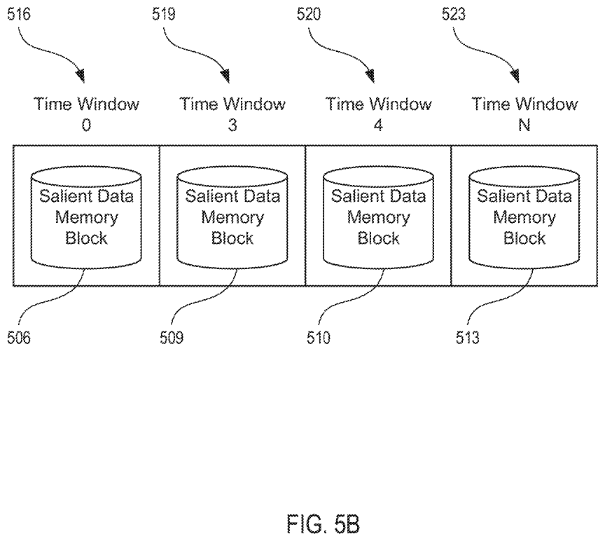

FIG. 5A illustrates an example collection of memory blocks 506-513 of sensor data and associated feature vectors. Each memory block 506-513 may comprise a time window indicator, feature vectors, and/or sensor data collected during an associated time window. In this example, the first memory block 506 is associated with time window 0 516 while the last memory block 513 is associated with time window N 523.

FIG. 5B illustrates the memory blocks 506, 509, 510, and 513 that contain salient sensor data, as determined by one or more saliency subsystems. A saliency subsystem may be embodied as a machine learning model trained to decide which feature vectors are more or less interesting. Object identification is one possible test of saliency. However, alternative embodiments may include machine learning models that determine saliency based on an activity amount. In still other embodiments, different objects and/or detected actions may each be associated with a relevancy score. Saliency may be determined based on a sum of the relevancy scores of objects and/or actions detected by the saliency subsystem. Images or videos that include a sum relevancy score above a saliency threshold.

The salient data memory blocks 506, 509, 510, and 513 are stored in the salient data memory. The salient data memory blocks may comprise a time window indicator, feature vectors, and/or sensor data collected during an associated time window. Memory blocks that do not contain salient sensor data are not stored in salient data memory. In this example, salient data memory blocks associated with time window 0 516, time window 3 519, time window 4 520, and time window N 523 contain salient sensor data and are stored in a salient sensor data memory.

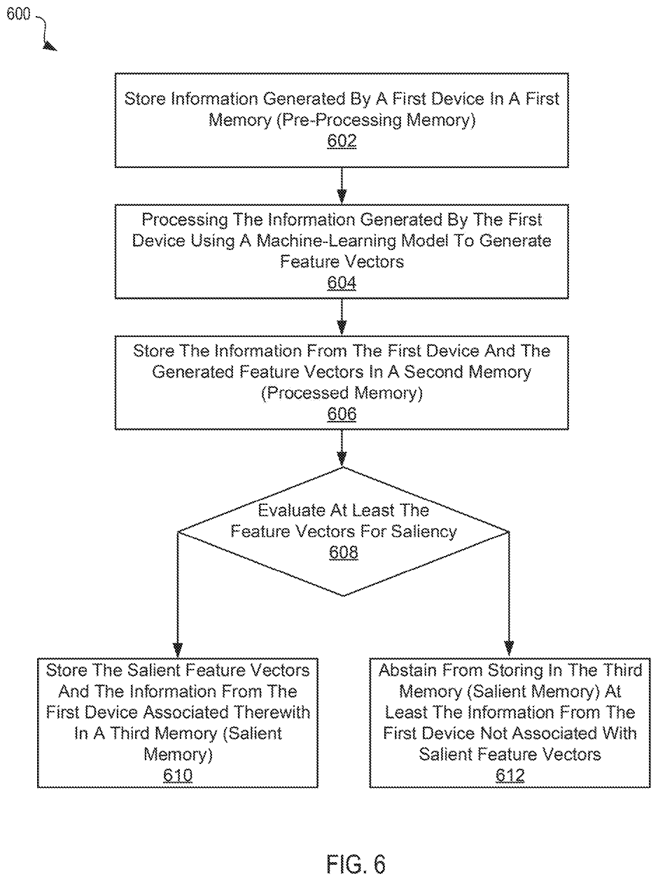

FIG. 6 illustrates a flow chart 600 of a method that may be implemented in software, firmware, hardware, and/or a combination thereof. A first or pre-processing memory stores, at 602, information generated by a first device. A processing subsystem may process, at 604, the information generated by the first device during a plurality of time periods by applying a machine-learning model to generate feature vectors.

A second or processed memory may store, at 606, the information of the first device and the first feature vectors. A saliency subsystem may evaluate, at 608, at least the feature vectors for saliency. A third or salient memory to store, at 610, the salient feature vectors and the information from the first device associated with the salient feature vectors. The third memory abstains, at 612, from storing (e.g., does not store or discards) at least the information from the first device that is not associated with salient feature vectors. In some examples, all the feature vectors, salient and non-salient, may be stored in the third memory while only the information from the first device associated with salient features vectors is stored within the third memory.

Specific examples of the disclosure are described above and illustrated in the figures. It is, however, appreciated that many adaptations and modifications can be made to the specific configurations and components detailed above. In some cases, well-known features, structures, and/or operations are not shown or described in detail. Furthermore, the described features, structures, or operations may be combined in any suitable manner in one or more examples. It is also appreciated that the components of the examples as generally described, and as described in conjunction with the figures herein, can be arranged and designed in a wide variety of different configurations. Thus, all feasible permutations and combinations of examples are contemplated. Furthermore, it is appreciated that changes may be made to the details of the above-described examples without departing from the underlying principles thereof.

In the description above, various features are sometimes grouped together in a single example, figure, or description thereof for the purpose of streamlining the disclosure. This method of disclosure, however, is not to be interpreted as reflecting an intention that any claim now presented or presented in the future requires more features than those expressly recited in that claim. Rather, it is appreciated that inventive aspects lie in a combination of fewer than all features of any single foregoing disclosed example. The claims are hereby expressly incorporated into this Detailed Description, with each claim standing on its own as a separate example. This disclosure includes all permutations and combinations of the independent claims with their dependent claims.

What is claimed is:

1. A system, comprising:
a first data storage to store processed data that includes:
sensor data generated by a sensor, and
feature vectors associated with the sensor data, wherein the feature vectors are generated by a processing subsystem processing the sensor data; and
a second data storage to store salient data, wherein the salient data includes a reduced subset of the feature vectors and associated sensor data determined to be salient by a saliency subsystem.

2. The system of claim 1, wherein the salient data includes the reduced set of feature vectors and associated sensor data as one of the following:
the feature vectors generated by the processing subsystem determined to be salient by the saliency subsystem and all the sensor data generated by the sensor;
all the feature vectors generated by the processing subsystem and a reduced subset of the sensor data associated with the feature vectors determined to be salient by the saliency subsystem; and
the feature vectors generated by the processing subsystem determined to be salient by the saliency subsystem and the sensor data associated with the feature vectors generated by the processing subsystem determined to be salient by the saliency subsystem.

3. The system of claim 1, wherein the first data storage and the second data storage are physically distinct data storage mediums.

4. The system of claim 1, further comprising a pre-processing data storage to store sensor data generated by the sensor prior to processing via the processing subsystem.

5. The system of claim 3, wherein the pre-processing data storage is configured to store sensor data generated by a first sensor and a second sensor during a first time period and a second time period; and
wherein the processed data includes:
the sensor data from the first sensor and the second sensor during the first and second time periods, and
feature vectors associated with the sensor data from the first sensor during each of the first and second time periods; and
wherein the salient data stored by the second data storage includes:
a reduced set of the feature vectors associated with the sensor data from the first sensor during the first time period, and
the sensor data from the from the first and second sensors during the first time period.

6. A system, comprising:
a first sensor to generate first sensor data during a plurality of time periods;
a first data storage to store the first sensor data from the first sensor;
a machine-learning subsystem to determine feature vectors associated with portions of the first sensor data from at least some of the time periods;
a second data storage to store the first sensor data and the feature vectors determined by the machine-learning subsystem;
a saliency subsystem to evaluate at least the feature vectors stored in the second data storage for saliency; and
a third data storage to store a reduced set of the feature vectors and associated first sensor data from a subset of the time periods determined to be salient by the saliency subsystem.

7. The system of claim 6, further comprising a second sensor to generate second sensor data during the plurality of time periods, and
wherein the first data storage is further configured to store the second sensor data,
wherein the second data storage is further configured to store the second sensor data, and
wherein the third data storage is further configured to store a reduced subset of the second sensor data from the subset of the time periods for which the feature vectors associated with the first sensor data are determined to be salient by the saliency subsystem.

8. The system of claim 6, wherein the machine-learning subsystem comprises a convolutional neural network to facilitate a convolutional analysis of the first sensor data.

9. The system of claim 6, wherein the first sensor data is divided into discrete memory blocks for each of the plurality of time periods,
wherein the machine-learning subsystem generates feature vectors for at least some of the memory blocks, and
wherein the saliency subsystem evaluates the feature vectors to identify some of the memory blocks as salient and some of the memory blocks as non-salient, and
wherein the third data storage is configured to store the memory blocks identified as salient to the exclusion of the memory blocks identified as non-salient.

10. The system of claim 6, wherein the first data storage comprises a temporary local storage of the first sensor,
wherein the second data storage comprises a temporary data storage that is remotely located relative to the first sensor, and
wherein the third data storage comprises a persistent data storage that is remotely located relative to the first sensor.

11. A method, comprising:
storing, in a first memory, information generated by a first device during a plurality of time periods;
processing, via a processing subsystem, the information of the first device using a first machine-learning model to generate first feature vectors associated with portions of the information of the first device;
storing, in a second memory, the information of the first device and the first feature vectors;
evaluating at least the first feature vectors for saliency to identify a reduced set of the first feature vectors as first salient feature vectors; and
storing, in a third memory:
the first salient feature vectors, and
a subset of information of the first device from the time periods corresponding to time periods associated with the first salient feature vectors.

12. The method of claim 11, wherein the first device comprises an image capture device to capture at least one of: a still image and video footage.

13. The method of claim 11, further comprising:
storing, in the first memory, information generated by a second device during the same plurality of time periods;
processing, via the processing subsystem, the information of the second device using a second machine-learning model to generate second feature-vectors associated with portions of the information of the second device;
storing, in the second memory, the information of the second device and the second feature vectors;
evaluating at least the second feature vectors for saliency to identify a reduced set of the second feature vectors as second salient feature vectors; and
storing, in the third memory:
the second salient feature vectors, and
a subset of the information of the second device from the time periods corresponding to time periods associated with the second salient feature vectors.

14. The method of claim 13, further comprising:
storing, in the third memory, the information of the first device from the time periods corresponding to the time periods of the second salient feature vectors; and
storing, in the third memory, the information of the second device from the time periods corresponding to the time periods of the first salient feature vectors.

15. The method of claim 13, wherein the first device comprises an image capture device, and wherein the second device comprises an audio capture device.
